(19) United States
(12) Patent Application Publication
(10) Pub. No.: US 2017/0085561 A1
(43) Pub. Date: Mar. 23, 2017

(54) KEY STORAGE DEVICE AND METHOD FOR USING SAME

(71) Applicant: Beijing Stone Shield Technology Co., Ltd.., Beijing (CN)

(72) Inventors: Sheng HAN, Beijing (CN); Ying WANG, Beijing (CN)

(73) Assignee: Beijing Stone Shield Technology Co., Ltd., Beijing (CN)

(21) Appl. No.: 14/902,396

(22) PCT Filed: Jul. 18, 2014
(86) PCT No.: PCT/CN2014/082518

§ 371 Date: Dec. 31, 2015

(30) Foreign Application Priority Data
Jun. 9, 2014 (CN) 201410254187.8
Jun. 9, 2014 (CN) 201420304960.2

(51) Int. Cl. H04L 29/06; H04W 12/06; G06F 3/14; H04W 12/04

(52) U.S. Cl. CPC H04L 63/0861; H04L 63/061; H04L 63/083; H04W 12/04; H04W 12/06; G06F 3/14; H04W 4/008

(57) ABSTRACT

Disclosed are a key storage device and a method for using same, so as to improve security of storage and use of a key, and further improve the security of a process of identity verification. The key storage device comprises: a security module (11), configured to store a key, the key being used for verifying an identity of a user; an operational module (12), configured to generate identity verification information when identity verification needs to be performed, the identity verification information at least comprising processed seed information obtained after the seed information is processed by using the key stored in the security module, and the seed information being any information that can be processed by a computer system; and a key exchange module (13), configured to exchange the identity verification information with an external device.

This application claims the benefit of Chinese Patent Applications Nos. 201410254187.8 and 201420304960.2, filed with the State Intellectual Property Office of People's Republic of China on Jun. 9, 2014 and entitled “Key storage device and method of using the same”, and “Key storage device”, both of which are hereby incorporated by reference in their entireties.

### FIELD

The present invention relates to the field of information security and particularly to a key storage device, and a method of using the same.

### BACKGROUND

There are more and more Internet applications available over the Internet along with rapid development of Internet technologies and particularly mobile Internet technologies. When a user accesses these Internet applications, e.g., an email, an instant communication application, a website, etc., providers of the respective Internet applications typically need to verify the identity of the user when the user logins, in order to secure the access of the user.

At present, the most common identity verification methods involve a password, a key, a certificate, etc., wherein the password is typically composed of uppercase letters and/or lowercase letters, digits, and characters which can be entered, the key is typically a file or a string of characters generated in a particular algorithm, and the certificate is also a special file issued by a particular institution, and all these methods are essentially identical in that the identity of a party is verified against unique data known to or possessed by only the party, wherein the data can be collectively referred to as a key. In an Internet application for higher security is required, e.g., an online bank, an online payment application, etc., other secondary identity verifying means will typically be further adopted, e.g., a verification code for a mobile phone, an RSA-SecurID two-factor authentication token, a smart card, etc.

In the existing identity verification methods, the password is somewhat limited in length, so if the password is set too short and simple, then it may be easily cracked; and if the password is set too long and complex, then it may not be convenient to memorize. Moreover the password being entered via a keypad may be easily stolen by malicious codes in a terminal device, thus degrading the security in verifying the identity.

If the verification code for the mobile phone is adopted as secondary identity verifying means, then since malicious codes easily injected into the smart phone may intercept the verification code for the mobile phone, distributed by the network side, the security in verifying the identity can not be guaranteed. The smart card limited in hardware may be difficult to popularize and poor in universality. The RSA-SecurID two-factor authentication token is widely applied in important information systems all over the world, but since 6 digits are used therein for verification, the authentication token can only be used as a verification code instead of the username and the primary password to verify the identity; and this method can only be applicable to a separate information system instead of being universally applied, so that the user typically has to hold a number of different SecurID tokens.

As can be apparent, it has been highly desired in the prior art to address the technical problem of how to improve the security of identity verification.

### SUMMARY

Embodiments of the invention provide a key storage device and a method of using the same so as to improve the security of key storage and use to thereby improve the security of identity verification.

An embodiment of the invention provides a key storage device including:

a security module configured to store a key for verifying the identity of a user.

an operation module configured to generate identity verification information when identity verification needs to be performed, wherein the identity verification information includes at least processed seed information into which seed information is processed using a key stored in the security module, and the seed information is any information processable by a computer system; and

a key exchange module configured to exchange the identity verification information with an external device.

An embodiment of the invention provides a method of using the key storage device above, the method including:

generating, by the operation module, identity verification information when identity verification needs to be performed, wherein the identity verification information includes at least processed seed information into which seed information is processed using a key stored in the security module, and the seed information is any information processable by a computer system; and

exchanging, by the key exchange module, the identity verification information with the external device after the operation module generates the identity verification information.

In the key storage device and the method of using the same according to the embodiments of the invention, the identity verification information is generated when identity verification needs to be performed, wherein the identity verification information includes at least the processed seed information into which the operation module processes the seed information using the key stored in the security module, and the key exchange module provides the external device with the generated identity verification information for identity verification to be performed. In the key storage device and the method of using the same according to the embodiments of the invention, since the key storage device processes the seed information using the stored key to generate the identity verification information in real time, and provides it to the external device for identity verification, the user will need to neither memorize any username and password nor input them via the keypad to thereby simplify the operations by the user and also avoid the problem of degrading the security of using the password if the password being input via the keypad is stolen; and on the other hand, the identity verification information generated from the processed seed information is more complex than a password that can be memorized by a person, and it is unique and can not be reproduced, so even if it is intercept on the way, then it can not be reused and falsified, to thereby improve the security of key storage and use and hence the security of identity verification.

Other features and advantages of the invention will be set forth in the following description, and will partly become apparent from the description or can be learned from the practice of the invention. The object and other advantages of the invention can be attained and achieved from the structures particularly pointed out in the written description, claims, and drawings.

### BRIEF DESCRIPTION OF THE DRAWINGS

The drawings described here are intended to provide further understanding of the invention and to constitute a part of the invention, and the exemplary embodiments of the invention and the description thereof are intended to illustrate the invention but not to limit the invention unduly. In the drawings:

FIG. 1A illustrates a schematic structural diagram of a first key storage device according to an embodiment of the invention;

FIG. 1B illustrates a schematic structural diagram of a second key storage device according to an embodiment of the invention;

FIG. 2 illustrates a schematic flow chart of a method of using the key storage device according to an embodiment of the invention;

FIG. 3 illustrates a schematic structural diagram of a first application system of the key storage device according to an embodiment of the invention;

FIG. 4 illustrates a schematic flow chart of a method of using the first application system according to an embodiment of the invention;

FIG. 5 illustrates a schematic structural diagram of a second application system of the key storage device according to an embodiment of the invention; and

FIG. 6 illustrates a schematic flow chart of a method of using the second application system according to an embodiment of the invention.

### DETAILED DESCRIPTION OF THE EMBODIMENTS

In order to improve the security of key storage and use and hence the security of identity verification, embodiments of the invention provide a key storage device and a method of using the same.

Preferred embodiments of the invention will be described below with reference to the drawings, but it shall be appreciated that the preferred embodiments described here are merely intended to describe and illustrate the invention but not to limit the invention, and the embodiments of the invention and features thereof may be combined with each other unless there is confliction between them.

### First Embodiment

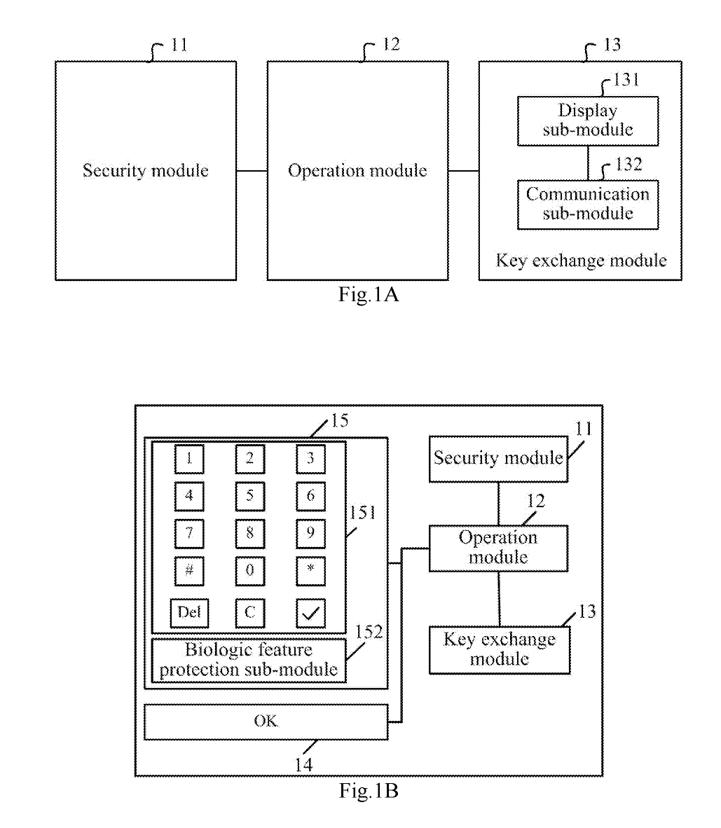

As illustrated in FIG. 1A, there is a schematic structural diagram of a key storage device according to an embodiment of the invention, wherein the device includes:

A security module 11 is configured to store a key for verifying the identity of a user.

An operation module 12 is configured to generate identity verification information when identity verification needs to be performed.

Particularly the identity verification information generated by the operation module 12 includes at least processed seed information into which seed information is processed using the key stored in the security module 11, wherein the seed information may be any information processable by a computer system, e.g., known fixed information (e.g., a name, a fixed number, etc.), a random number, a time, a cumulative counter, etc., but the invention will not be limited thereto as long as the information can be processed using a key. Preferably in a particular implementation, the seed information may be current time of the key storage device.

A key exchange module 13 is configured to exchange the identity verification information with an external device.

In a particular implementation, the key exchange module 13 may include a display sub-module 131 and/or a communication sub-module 132.

The display sub-module 131 may be configured to display the identity verification information generated by the operation module 12, and the external device may perform identity verification by obtaining the displayed identity verification information. Preferably the identity verification information displayed by the display sub-module 131 may be a graphic code which may be a one-dimension code (a bar code) or a two-dimension code, wherein the two-dimension code includes a standard two-dimension code and a non-standard two-dimension code (i.e., some variant two-dimension code, e.g., a round two-dimension code, a color two-dimension code, etc.), but the invention will not be limited thereto. Thus the external device may obtain the identity verification information displayed by the display sub-module 131 by scanning the identity verification information.

Preferably the display sub-module 131 may be but will not be limited to an LCD (Liquid Crystal Display), an LED (Light Emitting Diode) display, an OLED (Organic Light Emitting Diode) display, or an electronic ink screen.

The communication sub-module 132 may be configured to establish a communication connection with the external device, and to transmit the identity verification information generated by the operation module 12 to the external device over the established communication link. Preferably the communication sub-module 132 may establish the communication connection with the external device in any one of the following means without any limitation thereto: an earphone interface, Bluetooth, infrared, NFC (Near Field Communication), WIFI (Wireless Fidelity), a USB (Universal Serial Bus) interface, an OTG (data transmission interface), etc.

In a particular implementation, the operation module 12 may process the seed information using the key stored in the security module 11 as follows without any limitation thereto: it encrypts or signs the seed information using the key stored in the security module 11, or performs a hash operation on the seed information to obtain a corresponding hash value using the key stored in the security module 11. Particularly the operation module 12 may encrypt the seed information into ciphertext information corresponding to the seed information using the key stored in the security module 11; or the operation module may sign the seed information using the key stored in the security module 11 to obtain signed seed information; or the operation module may perform a hash operation on the seed information to obtain the corresponding hash value.

As illustrated in FIG. 1B, there is another possible schematic structural diagram of the key storage device according to the embodiment of the invention, wherein the device may further include a confirmation button 14 connected with the operation module 12. Hereupon if the user accessing the Internet needs to be verified for the identity thereof, then the confirmation button 14 may be pressed to trigger the operation module 12 of the key storage device to generate the identity verification information.

Preferably in order to improve the security of the key storage device being used, in a particular implementation, the key storage device may further include a physical protection module 15 connected with the operation module 12.

Particularly the physical protection module 15 may include a password protection sub-module 151 and/or a biologic feature protection sub-module 152.

In a particular implementation, the password protection sub-module 151 may be but will not be limited to a physical password keypad (including at least digital keys, or a qwerty keyboard) and an encryption chip, and the biologic feature protection sub-module 152 may be but will not be limited to any one of a fingerprint acquisition and recognition module, a voiceprint acquisition and recognition module, or an iris acquisition and recognition module.

Hereupon the key storage device may verify the identity of the user by firstly before generating the identity verification information, and then generate the identity verification information if identity verification is passed. Particularly the identity of the user may be verified in either of the following two approaches:

In a first approach, identity verification is performed using the password protection sub-module.

The password protection sub-module 151 pre-stores a password preset by the legal user, and if the user triggers the key storage device to generate the identity verification information, then the key storage device asks the user to input the preset password, and after the user inputs the password through the password protection sub-module 151, the password protection sub-module 151 compares the password input by the user with the locally stored password for consistency, and if they are consistent, then the password protection sub-module 151 instructs the operation module 12 to generate the identity verification information; otherwise, it notifies the user of an operation failure.

In a second approach, identity verification is performed using the biologic feature protection sub-module.

Hereupon the biologic feature protection sub-module 152 may pre-store biologic feature information of the legal user, e.g., fingerprint information, iris information, voiceprint information, etc. If the user triggers the key storage device to generate the identity verification information, then the key storage device asks the user to provide any one of the biologic feature information above, and after the biologic feature protection sub-module 152 acquires any one of the biologic feature information above, it compares the acquired fingerprint information with the locally stored fingerprint information for consistency, and if they are consistent, then the biologic feature protection sub-module 152 instructs the operation module 12 to generate the identity verification information; otherwise, it notifies the user of an operation failure.

Based upon the same inventive idea, an embodiment of the invention further provides a method of using the key storage device, and since the method addresses the problem under a similar principle to the key storage device, reference may be made to the implementation of the key storage device for an implementation of the method, so a repeated description thereof will be omitted here.

### Second Embodiment

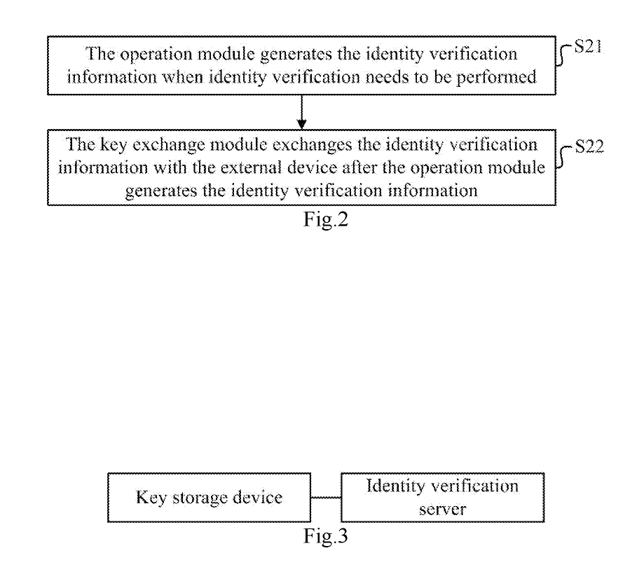

Based on the key storage device above, an embodiment of the invention further provides a corresponding method of using the same, and as illustrated in FIG. 2, the method may include the followings steps:

S21. The operation module generates the identity verification information when identity verification needs to be performed.

Particularly the identity verification information includes at least the processed seed information into which the seed information is processed using the key stored in the security module, wherein the seed information is any information processable by a computer system.

S22. The key exchange module exchanges the identity verification information with the external device after the operation module generates the identity verification information.

In a particular implementation, the key exchange module may exchange the identity verification information with the external device in either of the following approaches in the step S22:

In a first approach, the display sub-module included in the key exchange module displays the identity verification information generated by the operation module.

In a second approach, the communication sub-module included in the key exchange module establishes a communication link with an external device, and transmits the identity verification information generated by the operation module to the external device over the established communication connection.

In a particular implementation, the key storage device according to the embodiment of the invention may be applicable to the following three application scenarios where identity verification is required, which correspond respectively to three different implementations to be described below respectively.

### Third Embodiment

### First Implementation

As illustrated in FIG. 3, there is a schematic structural diagram of a first application system of the key storage device according to the embodiment of the invention, which includes the key storage device and an identity verification server.

The key storage device is configured to generate user identity verification information when identity verification needs to be performed, wherein the user identity verification information includes at least processed seed information into which seed information is processed using a stored key.

The identity verification server is configured to receive an identity verification request sent by a terminal device, wherein the identity verification request carries the processed seed information which is obtained by the terminal device from the identity verification information obtained from the key storage device; to search locally stored keys for a key corresponding to the key stored in the key storage device; to recover and/or verify the processed seed information using the found key; and to determine whether identity verification is passed based on a recovery result or a verification result.

For the sake of a convenient description, for example, the seed information is current time of the key storage device, so that the identity verification server may be configured to determine that identity verification is passed, upon determining that the interval between the recovered current time of the key storage device and the current time of the identity verification server lies in a preset time interval range; or may be configured to determine that identity verification is passed, upon determining that verification of the current time of the key storage device is passed.

Preferably the identity verification information generated by the key storage device may include but will not be limited to a graphic code, and the key storage device may generate the graphic code when identity verification needs to be performed, as follows: the operation module processes the seed information into the processed seed information using the key pre-stored in the security module. The operation module generates a graphic code using the processed seed information (the obtained cipher-text information or signed seed information or hash value above), and the graphic code is displayed by the display sub-module. Thus the terminal device may scan the graphic code displayed by the display sub-module for the processed seed information included in the graphic code. The terminal device sends an identity verification request, carrying the obtained processed seed information, to the identity verification server at the network side, and the identity verification server searches the locally stored keys for the key corresponding to the key stored in the key storage device, recovers/verifies the processed seed information using the found key, and determines whether identity verification is passed based on the recovery result or the verification result.

Preferably in a particular implementation, the identity verification system according to the embodiment of the invention may be embodied in a symmetric key encryption architecture or may be embodied in an asymmetric key encryption architecture. If the identity verification system is embodied in the symmetric key encryption architecture, then the keys stored in the security module are the same as the keys stored in the identity verification server. If the identity verification system is embodied in the asymmetric key encryption architecture, then a set of public and private keys may be generated randomly for each key storage device so that the private key is stored in the security module of the key storage device, and the public key is stored in the identity verification server. In comparison with the symmetric key encryption architecture, the asymmetric key encryption architecture can further improve the security of the identity verification system, and in this case, even if the identity verification server is intruded, an attacker can not login by pretending a user.

Particularly in the asymmetric key encryption architecture, if the key storage device signs the seed information using the private key, then the signed seed information may be verified using the public key stored in the identity verification server; and if the key storage device encrypts the seed information using the private key, then the encrypted seed information may be decrypted into the seed information using the public key stored in the identity verification server. In the symmetric key encryption architecture, if the key storage device signs the seed information using the stored key, then the signed seed information may be verified using the key stored in the identity verification server; if the key storage device encrypts the seed information using the stored key, then the encrypted seed information may be decrypted into the seed information, and then verified, using the key stored in the identity verification server, or the cipher text may be verified directly without being recovered; and if the key storage device performs a hash operation on the seed information in a hash algorithm to obtain the hash value, then the identity verification server may verify the obtained hash value.

In an example where the seed information is the current time of the key storage device, if the interval of time between the recovered current time of the key storage device and the current time of the identity verification server lies in the preset time interval range (which may be set a very short interval of time, for example), then it will be determined that identity verification is passed; otherwise, it will be determined that identity verification is not passed; or if it is determined that verification of the current time of the key storage device is passed, then it will be determined that identity verification is passed; otherwise, it will be determined that identity verification is not passed.

In the method above, the identity verification server will search all the locally stored keys for the key corresponding to the key stored in the key storage device, and recover and/or verify the processed seed information, upon reception of the identity verification request of the terminal device. Particularly the identity verification server may attempt on each of the locally stored keys in sequence until it can recover and/or verify the processed seed information.

Preferably in order to improve the efficiency of the identity verification server to recover and/or verify the processed seed information, in the embodiment of the invention, the identity verification information generated by the key storage device may further include a device identifier of the key storage device so that the terminal device can obtain the device identifier from the identity verification information, and carry it together with the processed seed information in the identity verification request, and send the identity verification request to the identity verification server, and the identity verification server may search a pre-stored correspondence relationship between device identifiers and keys, for a key corresponding to the device identifier directly according to the device identifier, and determine the found key as the key corresponding to the key stored in the key storage device.

### Fourth Embodiment

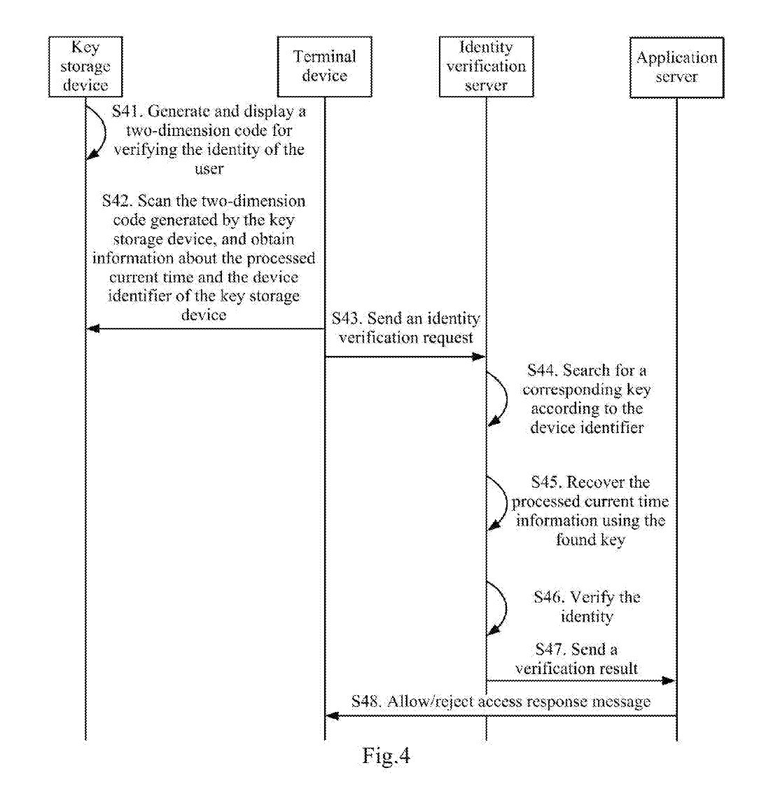

For better understanding of the embodiment of the invention, a particular implementation of the embodiment of the invention will be described below in combination with an information exchange flow in identity verification, and for the sake of a convenient description, the embodiment of the invention will be described in an example where a user accesses an online bank, and a flow in which the user logins the online bank is shown in FIG. 4, wherein the flow may include the following steps:

S41. The key storage device generates and displays a two-dimension code for verifying the identity of the user.

In a particular implementation, the user may access the online bank in the following two approaches:

In a first approach:

The user accesses the online bank using the terminal device which obtains the user identity verification information, for example, the user accesses the online bank using a mobile phone, and also obtains the user identity verification information generated by the key storage device, using the mobile phone. In this case, a logon page of the online bank accessed by the user will provide an application interface encapsulating the identity verification method according to the embodiment of the invention, and identity verification of the user will be triggered by invoking the application interface when the user needs to login the online bank.

In a second approach:

The user accesses the online bank using other terminal device than the terminal device which obtains the user identity verification information, for example, the user accesses the online bank using a computer, and obtains the user identity verification information generated by the key storage device, using his or her own mobile phone. In this case, a verifying program encapsulating the identity verification method according to the embodiment of the invention will be embedded in a logon page of the online bank, and displayed on the logon page in the form of a graphic code (which may include but will not be limited to a two-dimension code), and if the user needs to login the online bank, then the two-dimension code will be scanned directly to trigger identity verification of the user.

After identity verification of the user is triggered, the user triggers his or her own key storage device (which may be provided by the bank to the user when a bank account is registered by the user) to generate the user identity verification information, and for details thereof, reference may be made to the description in the first embodiment above, so a repeated description thereof will be omitted here.

Preferably in order to avoid a risk arising from a loss of the key storage device by the user, in the embodiment of the invention, the key storage device may further identify the user identity before generating the user identity verification information, for example, the key storage device may identify the user identity with his or her fingerprint or may identify the user identity with a password preset by the user, although the invention will not be limited thereto; and correspondingly the key storage device may further include a number key or fingerprint acquisition means.

S42. The terminal device scans the two-dimension code generated by the key storage device, and obtains information about the processed current time and the device identifier of the key storage device.

In a particular implementation, in the first approach, the terminal device may scan the user identity verification information generated by the key storage device by directly invoking the identity verification application realized on the basis of the identity verification method according to the embodiment of the invention. In the second approach, the user himself or herself starts the identity verification application, realized on the basis of the identity verification method according to the embodiment of the invention, installed in the terminal device to scan the user identity verification information generated by the key storage device.

S43. The terminal device sends an identity verification request to the identity verification server at the network side.

Particularly the identity verification request carries the obtained processed seed information, and the device identifier of the key storage device. Moreover the terminal device will further carry an application identifier or an application name of an Internet application accessed by the user, and a globally unique identifier of the Internet application in the identity verification request, wherein the unique identifier is a globally unique code and will not be repeated for any different Internet application, on any different terminal device, and at any different time. Preferably the unique code may include but will not be limited to a Universally Unique Identifier (UUID) or a Globally Unique Identifier (GUID), or of course, the unique code may alternatively be a similarly embodied global identifier, but for the sake of a convenient description, the unique code will be described as a UUID by way of an example.

If the user accesses an Internet application in the first approach, then the terminal device may directly obtain the application identifier or the application name of the Internet application being currently accessed by the user, and the UUID corresponding thereto, and send them together to the identity verification server; and if the user accesses an Internet application in the second approach, then a graphic code displayed on the generated logon page will include the application identifier or the application name of the Internet application, and the UUID corresponding to the Internet application so that the terminal device may scan the graphic code to obtain the application identifier or the application name of the Internet application, and the UUID corresponding to the Internet application, and send them to the identity verification server together with the processed seed information obtained from the two-dimension code generated by the key storage device, and the device identifier of the key storage device.

In a particular implementation, the terminal device may send the identity verification request to the identity verification server at the network side over a wired network, a wireless network, a mobile communication network, etc.

S44. The identity verification server searches for a corresponding key according to the device identifier carried in the identity verification request.

S45. The identity verification server recovers and/or verifies the processed current time information using the found key.

S46. The identity verification server performs identity verification.

In a particular implementation, in an example where the key storage device encrypts the current time, the identity verification server compares the recovered current time of the key storage device with the current time of the identity verification server, and if there is an interval of time lying in a preset time interval range, then it will be determined that verification is passed; otherwise, it is determined that verification is not passed.

S47. The identity verification server sends a verification result to an application server providing the Internet application.

In a particular implementation, the identity verification server provides the verification result to the application server corresponding to the application identifier or the application name according to the application identifier or the application name carried in the identity verification request, and carries the UUID of the Internet application currently accessed by the user in the sent verification result.

S48. The application server sends an allow/reject access response message to the terminal device.

In a particular implementation, the application server determines the terminal device with which the user accesses the Internet application, and the application according to the UUID, and sends the allow/reject Access response message to the terminal device according to the verification result.

In the existing security system for which the encryption mechanism is adopted, the security of the asymmetric key encryption technology has been sufficiently proved in theory and widely applied. However the most obvious drawback thereof may lie in that the key is too long to be memorized and entered directly by a person so that the user typically needs to store the key in a computer file or a hardware device, and to import it for use, thus resulting in a risk of leaking the key and inconvenience to use. In the embodiment of the invention, since the graphic code is a convenient automatic machine recognition technology to represent ciphertext information, and easy to be recognized, transmitted and decrypted. This can address such a problem in the existing asymmetric key encryption mechanism that the key is too long to use directly. Moreover in the embodiment of the invention, the graphic code may be generated in separate hardware to thereby avoid the private key from being stolen, copied and falsified, and the separate hardware is physically isolated from the Internet application accessed by the user to thereby substantially avoid a possibility of being invaded by a hacker, thus the first application system of the key storage device achieves extremely high security. Also in the embodiment of the invention, in the asymmetric key encryption mechanism, the private key is stored in the security module of the key storage device, and the public key is stored in the identity verification server, so that even if the identity verification server is invaded by a hacker, and the entire public key is leaked, then the attacker can not be verified by falsifying the identity of any user, thus the first application system of the key storage device precludes any risk of security. Lastly since the key is sufficiently long and strong, the device identifier of the key storage device (which may be a unique number thereof) may be used directly as a username, and the identity may be verified using the ciphertext information into which the seed information is encrypted, or the signed seed information as a password each time, so that there will be a password for each time of verification, and the password will be far more complex than a password which is set by an ordinary person, thus the first application system of the key storage device greatly improves both the security and the convenience.

### Second Implementation

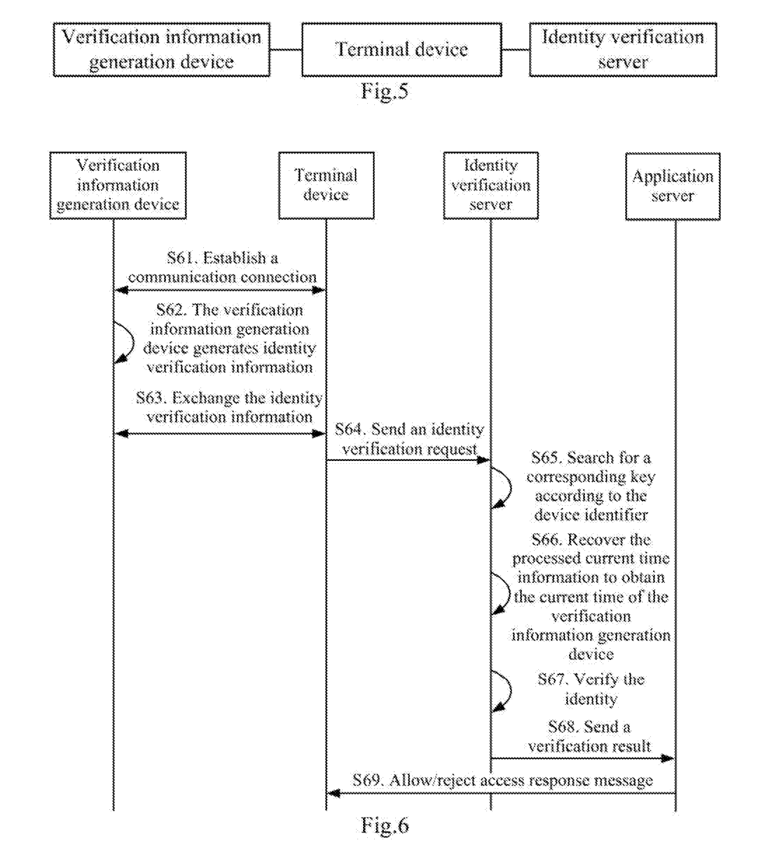

As illustrated in FIG. 5, there is a schematic structural diagram of a second application system of the key storage device according to the embodiment of the invention, which includes the key storage device, an identity verification server, and a terminal device.

The terminal device is configured to establish a communication link with a verification information generation device when identity verification in an access to an Internet application needs to be performed; and to interact with the verification information generation device over the established communication link to obtain identity verification information generated by the verification information generation device, and then send an identity verification request carrying the identity verification information to the identity verification server; the verification information generation device is configured to generate the identity verification information, and to exchange the identity verification information with the terminal device over the communication link established with the terminal device, wherein the identity verification information includes at least processed seed information into which seed information is processed using a stored first key, and the seed information is any information processable by a computer system; and the identity verification server is configured, upon reception of the identity verification request, to recover and/or verify the processed seed information included in the identity verification information using a locally stored second key corresponding to the first key, and to determine whether identity verification is passed according to a recovery result or a verification result.

In a particular implementation, if the identity of the user accessing the Internet application needs to be verified, then establishment of a communication connection between the terminal device and the verification information generation device may be triggered. Preferably the communication connection may be established between the terminal device and the verification information generation device in any one of the following means without any limitation thereto: an earphone interface, Bluetooth, infrared, NFC (Near Field Communication), WIFI (Wireless Fidelity), a USB (Universal Serial Bus) interface, an OTG (data transmission interface), etc.

In a particular implementation, after the communication link is established, the verification information generation device may exchange the locally generated identity verification information with the terminal device over the established communication link. In a particular implementation, the terminal device may retrieve on its own initiative the identity verification information generated by the verification information generation device, from the verification information generation device, or the verification information generation device may send on its own initiative the locally generated identity verification information to the terminal device, although the embodiment of the invention will not be limited in this regard. The identity verification information generated by the verification information generation device includes at least the processed seed information into which the seed information is processed by the verification information generation device using the stored first key.

For the sake of a convenient description, for example, the seed information is current time of the verification information generation device, so that the identity verification server may be configured to determine that identity verification is passed, upon determining that the interval between the recovered current time of the verification information generation device and the current time of the identity verification server lies in a preset time interval range; or may be configured to determine that identity verification is passed, upon determining that verification of the current time of the verification information generation device is passed.

The verification information generation device may generate the identity verification information when identity verification needs to be performed, as follows:

The operation module processes the seed information into the processed seed information using the key pre-stored in the security module (i.e., the first key). In a particular implementation, the operation module may encrypt the seed information into ciphertext information corresponding to the seed information using the key stored in the security module; or the operation module may sign the seed information using the key stored in the security module to obtain signed seed information; or the operation module may perform a hash operation on the seed information to obtain a corresponding hash value.

The communication sub-module sends the identity verification information carrying the processed seed information obtained by the operation module to the terminal device, or the terminal device may retrieve on its own initiative the identity verification information including the processed seed information from the communication sub-module. The terminal device carries the obtained processed seed information in the identity verification request and sends the identity verification request to the identity verification server at the network side, and the identity verification server searches locally stored keys for a key corresponding to the key stored in the verification information generation device (i.e., the second key), recovers and/or verifies the processed seed information using the found key, and determines from the recovery result or the verification result whether identity verification is passed.

Preferably in a particular implementation, the interactive identity verification system according to the embodiment of the invention may be embodied in a symmetric key encryption architecture or may be embodied in an asymmetric key encryption architecture. If the identity verification system is embodied in the symmetric key encryption architecture, then the keys stored in the security module of the verification information generation device are the same as the keys stored in the identity verification server. If the identity verification system is embodied in the asymmetric key encryption architecture, then a set of public and private keys may be generated randomly for each verification information generation device so that the private key is stored in the security module of the verification information generation device, and the public key is stored in the identity verification server. In comparison with the symmetric key encryption architecture, the asymmetric key encryption architecture can further improve the security of the identity verification system, and in this case, even if the identity verification server is intruded, then an attacker can not login by pretending a user.

Particularly in the asymmetric key encryption architecture, if the verification information generation device signs the seed information using the private key, then the signed seed information may be verified using the public key stored in the identity verification server; and if the verification information generation device encrypts the seed information using the private key, then the encrypted seed information may be decrypted into the seed information using the public key stored in the identity verification server. In the symmetric key encryption architecture, if the verification information generation device signs the seed information using the stored key, then the signed seed information may be verified using the key stored in the identity verification server; if the verification information generation device encrypts the seed information using the stored key, then the encrypted seed information may be decrypted into the seed information, and then verified, using the key stored in the identity verification server, or the cipher text may be verified directly without being recovered; and if the verification information generation device performs a hash operation on the seed information in a hash algorithm to obtain the hash value, then the identity verification server may verify the obtained hash value.

In an example where the seed information is the current time of the verification information generation device, if the interval of time between the recovered current time of the verification information generation device and the current time of the identity verification server lies in the preset time interval range (which may be set a very short interval of time, for example), then it will be determined that identity verification is passed; otherwise, it will be determined that identity verification is not passed; or if it is determined that verification of the current time of the verification information generation device is passed, then it will be determined that identity verification is passed; otherwise, it will be determined that identity verification is not passed.

In the method above, the identity verification server will search all the locally stored keys for the key corresponding to the key stored in the verification information generation device, and recover and/or verify the processed seed information, upon reception of the identity verification request of the terminal device. Particularly the identity verification server may attempt on each of the locally stored keys in sequence until it can recover and/or verify the processed seed information.

Preferably in order to improve the efficiency of the identity verification server to recover and/or verify the processed seed information, in the embodiment of the invention, the identity verification information generated by the verification information generation device may further include a device identifier of the verification information generation device so that the terminal device can obtain the device identifier from the identity verification information, and carry it together with the processed seed information in the identity verification request, and send the identity verification request to the identity verification server, and the identity verification server may search a pre-stored correspondence relationship between device identifiers and keys, for the key corresponding to the device identifier directly according to the device identifier, and determine the found key as the key corresponding to the key stored in the verification information generation device.

In a particular implementation, the terminal device may be further configured, before the identity verification request is sent to the identity verification server, to obtain an application identifier of the Internet application accessed by the user, and to carry the obtained application identifier in the identity verification request, and to send the identity verification request to the identity verification server, so that the identity verification server notifies an application server corresponding to the application identifier of the obtained identity verification result upon obtaining the identity verification result. Particularly the identity verification server may search a pre-stored correspondence relationship between application identifiers and application server identifiers for an application server identifier corresponding to the application identifier, and send the identity verification result to the application server corresponding to the application server identifier according to the found application server identifier.

In a particular implementation, the user may access the Internet application using the terminal device on which identity verification is performed, or may access the Internet application using another terminal device, so in the embodiment of the invention, the terminal device may obtain the application identifier of the Internet application accessed by the user in either of the following two approaches:

In a first approach, if the user accesses the Internet application using the terminal device on which identity verification is performed, then the terminal device may obtain the application identifier of the Internet application by invoking an interface provided by the Internet application; and if the user accesses the Internet application using another terminal device, then he or she may scan a graphic code (which may be but will not be limited to a two-dimension code) provided by the Internet application, using the terminal device to obtain the application identifier of the Internet application.

In a particular implementation, in order to improve the security of the access to the Internet application, after the terminal device establishes the communication connection with the verification information generation device, the terminal device may further obtain an application identification code of the Internet application accessed by the user, and send the obtained application identification code to the verification information generation device; the verification information generation device processes the application identification code using the locally stored first key, and then carries it in the identity verification information, and sends the identity verification information to the terminal device; and the terminal device carries the received processed application identification code in the identity verification request, and sends the identity verification request to the identity verification server. In a particular implementation, the terminal device may obtain the application identification code in the same way as the above-mentioned terminal device obtaining the application identifier, so a repeated description thereof will be omitted here.

Preferably the application identification code is a globally unique code and will not be repeated for any different Internet application, on any different terminal device, and at any different time. Preferably the application identification code may include but will not be limited to a Universally Unique Identifier (UUID) or a Globally Unique Identifier (GUID), or of course, the application identification code may alternatively be a similarly embodied global identifier, but for the sake of a convenient description, the unique code will be described as a UUID by way of an example.

After the identity verification server receives the processed application identification code, if the application identification code is encrypted by the verification information generation device, then the identity verification server will decrypt it using the locally stored second key and then send it to the corresponding application server together with the identity verification result, and the application server may determine the terminal device on which the user accesses the Internet application, according to the received application identification code, and send an allow/reject Access response message to the terminal device according to the identity verification result sent by the identity verification server.

### Sixth Embodiment

For better understanding of the embodiment of the invention, a particular implementation of the embodiment of the invention will be described below in connection with an information interaction flow in identity verification, and for the sake of a convenient description, the embodiment of the invention will be described in an example where a user accesses an online bank, and a flow in which the user logins the online bank is shown in FIG. 6, wherein the flow may include the following steps:

S61. While the user is accessing the Internet application, a communication connection is established between the terminal device and the verification information generation device.

In a particular implementation, the user may access the online bank in the following two approaches:

In a first approach:

The user accesses the online bank using the terminal device which obtains the identity verification information, for example, the user accesses the online bank using a mobile phone, and also obtains the identity verification information generated by the verification information generation device, using the mobile phone. In this case, a logon page of the online bank accessed by the user will provide an application interface encapsulating the identity verification method according to the embodiment of the invention, and identity verification of the user will be triggered by invoking the application interface when the user needs to login the online bank.

In a second approach:

The user accesses the online bank using other terminal device except the terminal device which obtains the identity verification information, for example, the user accesses the online bank using a computer, and obtains the identity verification information generated by the verification information generation device, using his or her own mobile phone. In this case, a verifying program encapsulating the identity verification method according to the embodiment of the invention will be embedded in a logon page of the online bank, and displayed on the logon page in the form of a graphic code (which may include but will not be limited to a two-dimension code), and if the user needs to login the online bank, then the two-dimension code will be scanned directly to trigger identity verification of the user.

S62. The verification information generation device generates the identity verification information.

After identity verification of the user is triggered, the user triggers his or her own verification information generation device (which may be provided by the bank to the user when a bank account is registered by the user) to generate the identity verification information. For example, the user triggers the verification information generation device using a button provided by the verification information generation device, to generate the identity verification information, wherein reference may be made to the description in the first embodiment above for details about generation of the identity verification information by the verification information generation device, so a repeated description thereof will be omitted here.

Preferably in order to avoid a risk arising from a loss of the verification information generation device by the user, in the embodiment of the invention, the verification information generation device may further identify the user identity before generating the identity verification information, for example, the verification information generation device may identify the user identity with his or her fingerprint, or may identify the user identity with a password preset by the user, although the invention will not be limited thereto; and correspondingly the verification information generation device may further include a number key or fingerprint acquisition means.

In a particular implementation, the step S62 may be performed before the step S61, that is, the verification information generation device firstly generates the identity verification information, and then establishes the communication connection with the terminal device, or may perform both of them at the same time, although the embodiment of the invention will not be limited thereto.

S63. The verification information generation device exchanges the locally generated identity verification information with the terminal device.

In a particular implementation, the verification information generation device may process the seed information into the processed seed information using the locally stored key, and carry the processed seed information and the device identifier thereof in the identity verification information, and send the identity verification information to the terminal device, or the terminal device may retrieve on its own initiative the identity verification information including the processed seed information from the communication sub-module.

S64. The terminal device sends an identity verification request to the identity verification server at the network side.

Particularly the identity verification request carries the obtained processed seed information, and the device identifier of the verification information generation device.

It shall be noted that the terminal device may further obtain an application identification code and an application identifier of an Internet application accessed by the user, and carry them together in the identity verification request, and send the identity verification request to the identity verification server.

In a particular implementation, the terminal device may obtain the application identifier of the Internet application accessed by the user before establishing the communication connection with the verification information generation device, or may obtain the application identifier of the Internet application accessed by the user after establishing the communication connection with the verification information generation device, or may obtain the application identifier of the Internet application accessed by the user after receiving the identity verification information, although the invention will not be limited in this regard as long as the application identifier is obtained before the identity verification request is sent.

For example, if the user accesses the Internet application in the first approach, then the terminal device may directly obtain the application identifier or the application name of the Internet application currently accessed by the user, and the UUID corresponding thereto, and send them together to the identity verification server; and if the user accesses the Internet application in the second approach, then a graphic code displayed on the generated logon page will include the application identifier or the application name of the Internet application, and the UUID corresponding to the Internet application so that the terminal device may scan the graphic code to obtain the application identifier or the application name of the Internet application, and the UUID corresponding to the Internet application, and send them to the identity verification server together with the processed seed information obtained from the two-dimension code generated by the verification information generation device, and the device identifier of the verification information generation device.

Preferably in order to improve the security of data transmission, the terminal device may send the obtained UUID to the identity verification server after sending it to the verification information generation device for processing, to thereby avoid it from being falsified while being transmitted. It shall be noted that if the terminal device sends the UUID to the verification information generation device for processing, then it will obtain the UUID and the application identifier before establishing the communication connection, or obtain the UUID and the application identifier after establishing the communication connection and before receiving the identity verification information, so that the verification information generation device may carry the processed UUID in the identity verification information and send the identity verification information to the terminal device.

In a particular implementation, the terminal device may send the identity verification request to the identity verification server at the network side over a wired network, a wireless network, a mobile communication network, etc.

S65. The identity verification server searches for a corresponding key according to the device identifier carried in the identity verification request.

S66. The identity verification server recovers and/or verifies the processed current time information using the found key.

S67. The identity verification server performs identity verification.

In a particular implementation, in an example where the verification information generation device encrypts the current time, the identity verification server compares the recovered current time of the verification information generation device with the current time of the identity verification server, and if there is an interval of time lying in a preset time interval range, then it will be determined that verification is passed; otherwise, it is determined that verification is not passed.

S68. The identity verification server sends a verification result to the application server providing the Internet application.

In a particular implementation, the identity verification server provides the verification result to the application server corresponding to the application identifier or the application name carried in the identity verification request according to the application identifier or the application name, and carries the UUID of the Internet application currently accessed by the user in the sent verification result.

S69. The application server sends an allow/reject Access response message to the terminal device according to the verification result.

In a particular implementation, the application server determines the terminal device with which the user accesses the Internet application, and the application according to the UUID, and sends the allow/reject Access response message to the terminal device according to the verification result.

In the existing security system for which the encryption mechanism is adopted, the security of the asymmetric key encryption technology has been sufficiently proved in theory and widely applied. However the most obvious drawback thereof may lie in that the key is too long to be memorized and entered directly by a person so that the user typically needs to store the key in a computer file or a hardware device, and to import it for use, thus resulting in a risk of leaking the key and inconvenience to use. In the embodiment of the invention, since the graphic code is a convenient automatic machine recognition technology to represent ciphertext information, and easy to be recognized, transmitted and decrypted. This can address such a problem in the existing asymmetric key encryption mechanism that the key is too long to use directly. Moreover in the embodiment of the invention, the identity verification information may be generated in separate hardware to thereby avoid the private key from being stolen, copied and falsified, thus the second application system of the key storage device achieves extremely high security. Also in the embodiment of the invention, in the asymmetric key encryption mechanism, the private key is stored in the security storage module of the verification information generation device, and the public key is stored in the identity verification server, so that even if the identity verification server is invaded by a hacker, and the entire public key is leaked, then the attacker can not be verified by falsifying the identity of any user, thus the second application system of the key storage device precludes any risk of security. Lastly since the key is sufficiently long and strong, the device identifier of the verification information generation device (which may be a unique number thereof) may be used directly as a username, and the identity may be verified using the ciphertext information into which the seed information is encrypted, or the signed information as a password each time, so that there will be a password for each time of verification, and the password will be far more complex than a password which is set by an ordinary person, thus the second application system of the key storage device greatly improves both the security and the convenience.

### Third Implementation

The identity verification system according to the embodiment of the invention may be further applicable to an enterprise entrance guard system, wherein an enterprise will be equipped only with a graphic code scanner (for example, which may be a camera), and provide every employee with a key storage device, and the entering employee may be verified by scanning identity verification information generated by the key storage device, and if the employee passes verification, then he or she will be allowed to enter, and also the entrance opening time and other information may be recorded.

In a particular implementation, the identity verification system according to the embodiment of the invention may provide the same key storage device for different Internet applications, or may provide separate key storage devices for Internet applications for which high security is required, e.g., an online bank, online payment, etc., and at this time the identity verification server will maintain a correspondence relationship between the application identifiers of the Internet applications, the device identifiers of the key storage devices corresponding thereto, and the keys to provide identity verification for the different Internet applications.

It shall be noted that the terminal device as referred to in the embodiment of the invention may be a mobile phone, a tablet computer, a Personal Digital Assistant (PDA), a smart watch, and other mobile terminal device, or may be a Personal Computer (PC) or other device as long as the terminal device is provided with a camera device or a scanner to scan the graphic code generated by the key storage device.

Moreover the Internet application as referred to in the embodiment of the invention, includes a website, an application client, etc., which can be accessed over the Internet/mobile Internet.

Thus in comparison with the traditional identity verification method, the identity verification method according to the embodiment of the invention provides higher security, and offers a highly complex password for each time of verification to thereby avoid a risk of the password being stolen; and the identity verification method according to the embodiment of the invention is more convenient and rapid because the user will not memorize and enter various different usernames and passwords but the graphic code may be scanned directly to thereby perform the identity verification process rapidly.

Since the password in the identity verification method according to the embodiment of the invention is much longer and stronger than the password which is set by the ordinary user, and the 6 pure digits used in the existing RSA-SecurID dual-factor authentication token, the password in the identity verification method may be used directly as the primary password to verify the identity.

Those skilled in the art shall appreciate that the embodiments of the invention may be embodied as a method, a system or a computer program product. Therefore the invention may be embodied in the form of an all-hardware embodiment, an all-software embodiment or an embodiment of software and hardware in combination. Furthermore the invention may be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram may be embodied in computer program instructions. These computer program instructions may be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions may also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions may also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept may make additional modifications and variations to these embodiments. Therefore the appended claims are intended to be construed as encompassing the preferred embodiments and all the modifications and variations coming into the scope of the invention.

Evidently those skilled in the art may make various modifications and variations to the invention without departing from the spirit and scope of the invention. Thus the invention is also intended to encompass these modifications and variations thereto so long as the modifications and variations come into the scope of the claims appended to the invention and their equivalents.

1. A key storage device, comprising:
a security module configured to store a key for verifying the identity of a user;
an operation module configured to generate identity verification information when identity verification needs to be performed, wherein the identity verification information comprises at least processed seed information into which seed information is processed using a key stored in the security module, and the seed information is any information processable by a computer system; and
a key exchange module configured to exchange the identity verification information with an external device.

2. The device according to claim 1, wherein the key exchange module is a display sub-module; and
the display sub-module is configured to display the identity verification information.

3. The device according to claim 2, wherein the display sub-module is a Liquid Crystal Display (LCD), a Light Emitting Diode (LED) display, an Organic Light Emitting Diode (OLED) display, or an electronic ink screen.

4. The device according to claim 1 wherein the identity verification information is a graphic code.

5. The device according to claim 1, wherein the key exchange module comprises a communication sub-module; and
the communication sub-module is configured to establish a communication connection with the external device, and to transmit the identity verification information to the external device over the established communication connection.

6. The device according to claim 5, wherein:
the communication sub-module is configured to establish the communication connection with the external device through any one of an earphone interface, Bluetooth, infrared, Near Field Communication (NFC), Wireless Fidelity (WIFI), a Universal Serial Bus (USB) interface, and an On-The-Go (OTG).

7. The device according to claim 1, wherein the seed information comprises current time of the device.

8. The device according to claim 1, wherein:
the operation module is configured to process the seed information using the key stored in the security module by encrypting, signing or performing a hash operation on the seed information using the key stored in the security module.

9. The device according to claim 1, wherein the device further comprises a confirmation button connected with the operation module.

10. The device according to claim 1, wherein the device further comprises a physical protection module connected with the operation module.

11. The device according to claim 10, wherein the physical protection module comprises a password protection sub-module and/or a biologic feature protection sub-module.

12. A method of using the key storage device according to claim 1, comprising:
generating, by the operation module, identity verification information when identity verification needs to be performed, wherein the identity verification information comprises at least processed seed information into which seed information is processed using a key stored in the security module, and the seed information is any information processable by a computer system; and
exchanging, by the key exchange module, the identity verification information with the external device after the operation module generates the identity verification information.

13. The method according to claim 12, wherein exchanging, by the key exchange module, the identity verification information with the external device comprises:
displaying, by the display sub-module comprised in the key exchange module, the identity verification information.

14. The method according to claim 12, wherein exchanging, by the key exchange module, the identity verification information with the external device comprises:
establishing, by the communication sub-module comprised in the key exchange module, a communication link with the external device, and transmitting the identity verification information to the external device over the established communication connection.

15. The method according to claim 12, wherein the seed information comprises current time of the device.

16. The method according to claim 12, wherein processing, by the operation module, the seed information using a key stored in the security module comprises:
encrypting, signing or performing a hash operation, by the operation module, on the seed information using the key stored in the security module.

17. The method according to claim 12, wherein the device further comprises a confirmation button connected with the operation module.

18. The method according to claim 12, wherein the device further comprises a physical protection module connected with the operation module.

19. The method according to claim 18, wherein the physical protection module comprises a password protection sub-module and/or a biologic feature protection sub-module.
